(19) United States
(12) Patent Application Publication
(10) Pub. No.: US 2003/0192053 A1
(43) Pub. Date: Oct. 9, 2003

(54) Method and apparatus for transmitting wireless signals over media

(75) Inventors: Steve Sheppard, Sebastopol, CA (US); James L. Swisher, Santa Clara, CA (US); Charles Eldering, Doylestown, PA (US); Thomas Eames, Santa Rosa, CA (US)

Correspondence Address: COVINGTON & BURLING, ATTN: PATENT DOCKETING, 1201 PENNSYLVANIA AVENUE, N.W., WASHINGTON, DC, 20004-2401, US

(73) Assignee: NEXT LEVEL COMMUNICATIONS, INC., Rohnert Park, CA (US)

(21) Appl. No.: 10/443,744

(22) Filed: May 23, 2003

Related U.S. Application Data
(63) Continuation of application No. 09/525,488, filed on Mar. 15, 2000.
Application No. 09/525,488 is a continuation-in-part of application No. 09/488,275, filed on Jan. 20, 2000.
Application No. 09/488,275 is a continuation of application No. 09/026,036, filed on Feb. 19, 1998, now Pat. No. 6,317,884.
(60) Provisional application No. 60/038,276, filed on Feb. 19, 1997.

(51) Int. Cl. H04N 7/18

(52) U.S. Cl. 725/81; 725/82

(57) ABSTRACT

A residential gateway (RG) for distributing video, data and telephony services to multiple devices within a residence is disclosed. The RG receives signals from a telecommunications network, converts the signals to formats compatible with the multiple devices, and transmits the appropriate signals to the appropriate devices. Wireless remote control devices associated with remotely located televisions (TVs) transmit channel select commands as wireless signals to the RG. The wireless signals are received by a Remote Antennae Package (RAP) that transmits the wireless signal over cable. A Remote Antennae Module (RAM) receives the wireless signal and extracts the channel select command.

This application is a continuation of, and claims the benefit under 35 U.S.C. § 120 of, co-pending U.S. patent application Ser. No. 09/525,488, filed Mar. 15, 2000, which was a continuation-in-part (CIP) of U.S. patent application Ser. No. 09/488,275, filed Jan. 20, 2000, which was a continuation of U.S. patent application Ser. No. 09/026,036 (now abandoned), filed Oct. 12, 1999, which was a continuing prosecution application of U.S. patent application Ser. No. 09/026,036, filed on Feb. 19, 1998, which claimed priority to U.S. provisional patent application No. 60/038,276, filed on Feb. 19, 1997. Each of U.S. patent applications Ser. Nos. 09/488,275, 09/026,036, and 60/038,276 is hereby incorporated by reference in its entirety.

### FIELD OF THE INVENTION

The present invention relates to an apparatus and method for the distribution of video, data, telephony and other telecommunications services from a single point to multiple devices within a residence.

### BACKGROUND OF THE INVENTION

Advances in the field of telecommunications allow large amounts of digital information to be delivered to a residence. Digital telecommunications networks (access systems), such as Hybrid-Fiber-Coax (HFC), Fiber-to-the-Curb (FTTC), and Digital Subscriber Line (DSL), can provide both traditional telecommunications services such as Plain Old Telephone Service (POTS) as well as advanced services such as Switched Digital Video (SDV) and high-speed data access. Devices inside the residence, will be connected to the network by twisted wire pairs which provide telephone services today, or by coaxial cable similar to that used by cable operators to provide cable TV services. Because of this range of services, it is likely that digital networks will be widely deployed. In a widespread deployment of digital networks, millions of homes will connect to the digital network.

Because the majority of new video services will be digital, and because existing televisions (TVs) are analog, there is a requirement for a device which converts the digital signals supplied by the network to analog signals compatible with existing TVs. Presently available TV set-tops can perform this function, but are expensive. Moreover, many homes have more than one TV, and would therefore require multiple TV set-tops to receive and convert the digital signals at each location within the home. Furthermore, there is a need for an interface subsystem for each device connected to the digital network. For example, a Premises Interface Device (PID) to extract time division multiplexed information and generate a telephone signal, and an Ethernet Bridge or Router (EBR) to generate a signal compatible with a computer.

For the foregoing reasons, there is a need for a centralized unit in the residence which can provide: a central connectivity point to the digital network; digital to analog conversion; and supporting communications with multiple locations within the home (e.g., telephone, computer, TV). A centrally located in-home device is usually referred to as a residential gateway (RG).

### SUMMARY OF THE INVENTION

The present invention discloses a method and an apparatus for receiving signals from a telecommunications network, decoding the signals, and transmitting the decoded signals to a plurality of devices. In a preferred embodiment, the telecommunications network is a digital network and the signals include video signals, and may possibly include telephone signals, computer signals, and signals for other devices. In a preferred embodiment, the plurality of devices includes multiple televisions (TVs) and may possibly include telephones, computers and other devices. The apparatus is commonly known as residential gateway (RG).

In one embodiment, a method of distributing video signals from a RG within a residential environment having a plurality of TVs locatable in at least two separate locations is disclosed. The method includes receiving at least one channel select command from one of a plurality of remote control devices associated with a respective one of the plurality of TVs. At least a first one of the plurality of remote control devices is a wireless remote control device that transmits the channel select command as a wireless signal. A video signal from a telecommunications network is received in response to the at least one channel select command. At least one series of video packets corresponding to the at least one channel select command is constructed from the video signal. The at least one series of video packets is transmitted over a video packet bus to a plurality of video decoders. The at least one series of video packets is decoded to produce at least one TV signal. The decoding is performed by at least one of the plurality of video decoders.

In one embodiment, a method of distributing video signals from a RG within a residential environment having a plurality of TVs locatable in at least two separate locations is disclosed. The method includes receiving at least one channel select command from one of a plurality of remote control devices associated with a respective one of the plurality of TVs. At least a first one of the plurality of remote control devices is a optical remote control device that transmits the channel select command directly to the RG as a optical signal. A video signal from a telecommunications network is received in response to the at least one channel select command. At least one series of video packets corresponding to the at least one channel select command is constructed from the video signal. The at least one series of video packets is transmitted over a video packet bus to a plurality of video decoders. The at least one series of video packets is decoded to produce at least one TV signal. The decoding is performed by at least one of the plurality of video decoders.

In one embodiment, a RG for distributing video signals to a plurality of TVs locatable within at least two separate locations in a residential environment is disclosed. The RG includes a plurality of remote control devices associated with a respective one of the plurality of TVs for transmitting channel select commands. At least a first one of the plurality of remote control devices is a wireless remote control device that transmits the channel select command as a wireless signal. A network interface module receives signals including video signals from a telecommunications network. The received video signals correspond to the channel select commands. A means for constructing at least one series of video packets from the received video signals is provided. A plurality of video processors decode the at least one series of video packets to produce at least one TV signal. A video packet bus transports the at least one series of video packets to the plurality of video processors.

In one embodiment, a RG for distributing video signals to a plurality of TVs locatable within at least two separate locations in a residential environment is disclosed. The RG includes a plurality of remote control devices associated with a respective one of the plurality of TVs for transmitting channel select commands. At least a first one of the plurality of remote control devices is a optical remote control device that transmits the channel select command directly to the RG as a optical signal. A network interface module receives signals including video signals from a telecommunications network. The received video signals correspond to the channel select commands. A means for constructing at least one series of video packets from the received video signals is provided. A plurality of video processors decode the at least one series of video packets to produce at least one TV signal. A video packet bus transports the at least one series of video packets to the plurality of video processors.

In one embodiment, a method for receiving and decoding signals from a telecommunications network at a RG, and transmitting decoded signals from the RG to a plurality of devices including multiple TVs is disclosed. The method includes connecting the RG to the telecommunications network and to each of the plurality of devices so that all communications between the devices and the telecommunications network must pass through the RG. A first one of the multiple TVs can be directly coupled to and located in close proximity to the RG. A TV channel is selected for at least one of the multiple TVs by programming an associated remote control device to transmit a channel select command. Each of the multiple TVs have an associated remote control device and the remote control device associated with the first TV transmits the channel select command to a receiver within the RG. The at least one channel select command is transmitted to the telecommunications network. A video signal is received from the telecommunications network corresponding to the at least one channel select command. The video signal is converted into at least one series of video packets. The at least one series of video packets is decoded into at least one TV signal. The decoding performed by at least one of a plurality of video decoders. The at least one TV signal is then transmitted to the appropriate TV.

In one embodiment, a RG for receiving and decoding signals from a telecommunications network and transmitting decoded signals to a plurality of devices including multiple TVs is disclosed. The RG includes a network interface module for receiving the signals, including video signals, from the telecommunications network. A means for converting the video signal into at least one series of video packets is provided. A plurality of video decoders decodes the at least one series of video packets into at least one TV signal corresponding to at least one channel select command, and transmits the at least one TV signal to the corresponding TV. A receiver receives the channel select commands from a first remote control device associated with a first one of the multiple TVs that can be directly coupled to and in close proximity to the RG.

In one embodiment, a method for receiving and decoding signals from a telecommunications network at a RG, and transmitting the decoded signals from the RG to a plurality of devices including multiple TVs is disclosed. The method includes connecting the RG to the telecommunications network and to each of the plurality of devices that will communicate with the telecommunications network through the RG. A TV channel to view for at least one of the multiple TVs is selected by programming an associated remote control device to transmit a channel select command. At least one of the remote control devices transmits the channel select command directly to a receiver within the RG. The at least one channel select command is transmitted to the telecommunications network. A video signal is received from the telecommunications network corresponding to the at least one channel select command. The video signal is decoded into at least one TV signal. The decoding is performed by at least one of a plurality of video decoders. The at least one TV signal is transmitted to the appropriate TV.

In one embodiment, a RG for receiving and decoding signals from a telecommunications network and transmitting the decoded signals to a plurality of devices including multiple TVs is disclosed. The RG includes: a network interface module for receiving the signals, including video signals, from the telecommunications network; a plurality of video decoders for decoding the video signals into at least one TV signal corresponding to at least one channel select command, and transmitting the at least one TV signal to the corresponding TV; and a receiver for directly receiving channel select commands from at least one remote control device associated with one of the multiple TVs.

In one embodiment, a method for receiving and decoding signals from a telecommunications network at a RG, and transmitting the decoded signals from the RG to a plurality of devices including multiple TVs is disclosed. The method includes: connecting the RG to the telecommunications network and to at least one TV that is remotely located from the RG; selecting a TV channel to view for the at least one TV by programming an associated wireless remote control device, wherein the wireless remote control device transmits a channel select command as a wireless signal to a remote antennae package connected to the TV, the remote antennae package receives the wireless signal and transmits the wireless signal over cable to a remote antennae module which demodulates the wireless signal and extracts the portion corresponding to the channel select command; transmitting the channel select command to the telecommunications network; receiving a video signal from the telecommunications network corresponding to the channel select command; decoding the video signal into a TV signal, the decoding performed by one of multiple video decoders associated with the multiple TVs; and transmitting the TV signal to the at least one TV.

In one embodiment, a RG for receiving and decoding signals from a telecommunications network and transmitting the decoded signals to a plurality of devices including multiple TVs is disclosed. The RG includes: a network interface module for transmitting upstream signals, including channel select commands, to the telecommunications network and receiving downstream signals, including video signals, from the telecommunications network; a plurality of video decoders for decoding the video signals into at least one TV signal corresponding to at least one channel select command, and transmitting the at least one TV signal to the corresponding TV; and a remote control device for processing the channel select commands. At least one of the channel select commands is extracted from a wireless signal which was transmitted from a wireless remote control device to a remote antennae package connected to the associated TV. The remote antennae package transmits the wireless signal over cable to a remote antennae module which demodulates the wireless signal and extracts the portion corresponding to the channel select command.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a hybrid-fiber-coax (HFC) access system;

FIG. 2 illustrates a fiber-to-the-curb (FTTC) access system;

FIG. 3 illustrates an FTTC access system including a residential gateway (RG), according to one embodiment;

FIG. 4 illustrates a Digital Subscriber Line (DSL) access system including an RG, according to one embodiment;

FIG. 5 illustrates an RG architecture, according to one embodiment;

FIG. 6 illustrates the use of the RG with the residence, according to one embodiment;

FIG. 7 illustrates the use of the RG with the residence, according to one embodiment;

FIG. 8 illustrates an RG architecture, according to one embodiment;

FIG. 9 illustrates a schematic of the RG configuration of FIG. 7;

FIG. 10 illustrates a schematic of the Remote Antennae Package (RAP), according to one embodiment; and

FIG. 11 illustrates a schematic of the Remote Antennae Module (RAM), according to one embodiment.

### DETAILED DESCRIPTION OF THE PREFERRED EMBODIMENTS

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

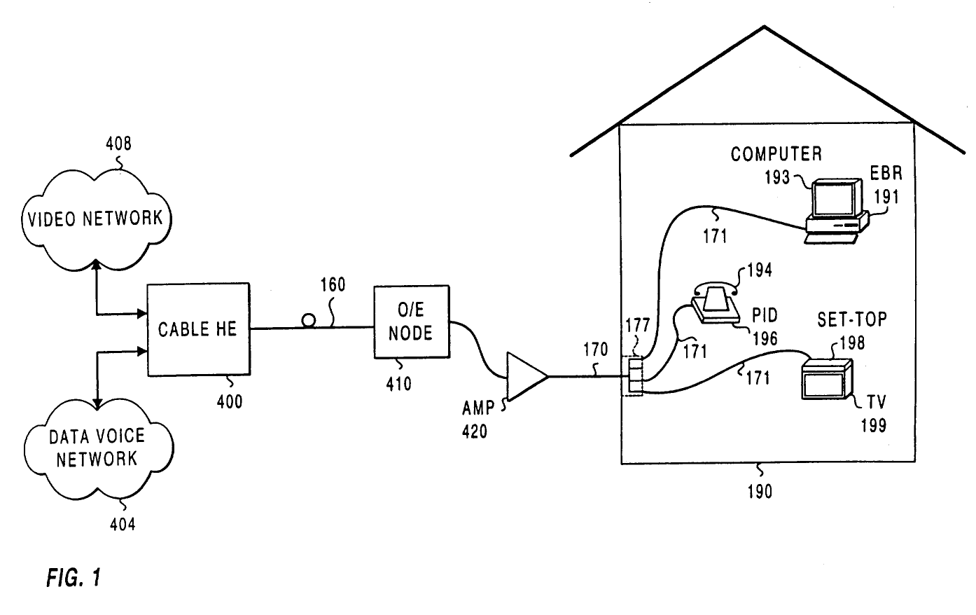

With reference to the drawings, in general, and FIGS. 1 through 11 in particular, the method and apparatus of the present invention are disclosed.

FIG. 1 illustrates a Hybrid-Fiber-Coax (HFC) digital network in which various devices within a residence 190 are connected to a Video Network (VN) 408 or a data and voice network (DVN) 404. The devices in the residence 190 can include a Premises Interface Device (PID) 196 connected to a telephone 194, a television (TV) set top-counter 198 connected to a TV 199, an Ethernet Bridge or Router (EBR) 191 connected to a computer 193, or other devices.

The HFC network illustrated in FIG. 1 works by connecting a cable headend (HE) 400 to the DVN 404 and the VN 408. The physical interface to the DVN 404 may be copper wire pairs carrying either DS-1 or DS-3 signals. The physical interface to the VN 408 may be via a wide area network (WAN).

The Cable HE 400 is connected to a plurality of optical to electrical (O/E) nodes 410 (only one illustrated) with fiber optic cables 160. The O/E nodes 410 are located within the communities serviced by the HFC network. Each O/E node 410 provides service for up to 500 residences within the given community. Since such a large number of users are being serviced by one O/E node 410, amplifiers 420 are required. The O/E node 410 connects to the residence 190 via coaxial cable 170. The coaxial cable 170 is received by a splitter 177 within the residence 190 so that internal coaxial wiring 171 can route the data being transmitted to the various devices. Each device connected to the internal coaxial wiring 171 will require an interface sub-system which can convert the current format of the signal being transmitted over the internal coaxial wiring 171 to the service interface required by the devices (i.e., telephone, TV, computer, or other devices). In a preferred embodiment, the PID 196 extracts time division multiplexed information carried on the internal coaxial wiring and generates a telephone signal compatible with the telephone 194. Similarly, the TV set-top 198 converts digital video signals to analog signals compatible with the TV 199. Likewise, the EBR 191 generates a signal compatible with the computer 193.

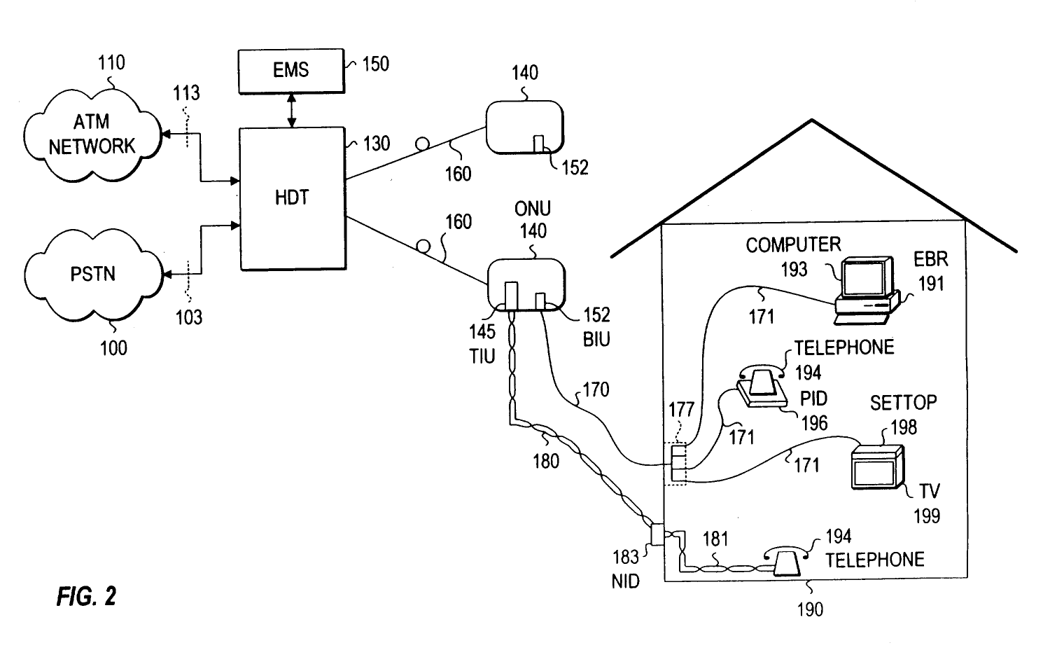

FIG. 2 illustrates a Fiber-to-the-Curb (FTTC) network in which various devices in the residence 190 are connected to a Public Switched Telecommunications Network (PSTN) 100 or an Asynchronous Transfer Mode (ATM) network 110. The devices in the residence 190 can include telephones 194 (with or without a PID 196), TV 199 with a TV set-top 198, and computer 193 with a EBR 191.

The FTTC network illustrated in FIG. 2 works by connecting a Host Digital Terminal (HDT) 130 to the PSTN 100 and the ATM network 110. A PSTN-HDT interface 103 is specified by standards bodies, and in the U.S. is specified by Bellcore specifications TR-TSY-000008, TR-NWT-000057 or GR-NWT-000303, which are incorporated herein by reference. The HDT 130 can also receive special service signals from private or non-switched public networks. The physical interface to the PSTN 100 may be twisted wire pairs carrying DS-1 signals, or optical fibers carrying Optical Carrier (OC)-3 optical signals.

An ATM network-HDT interface 113 can be realized using an OC-3 or OC-12c optical interface carrying ATM cells. In a preferred embodiment, the HDT 130 has three OC-12c broadcast ports, which receive signals carrying ATM cells, and one OC-12c interactive port which receives and transmits signals.

An element management system (EMS) 150 is connected to the HDT 130 and forms part of an Element Management Layer (EML) which is used to provision services and equipment on the FTTC network, in the central office where the HDT 130 is located, in the field, or in the residences 190. The EMS 150 is software based and can be run on a personal computer in which case it will support one HDT 130 and the associated digital network equipment connected to it, or can be run on a workstation to support multiple HDTs 130 and the associated digital network equipment.

Optical Network Units (ONUs) 140 are located in the serving area and are connected to the HDT 130 via optical fiber 160. Digital signals, having a format which is similar to the Synchronous Digital Hierarchy (SDH) format, are transmitted to and from each ONU 140 over the optical fiber 160 at a rate of at least 155 Mb/s, and preferably 622 Mb/s. In a preferred embodiment, the optical fiber 160 is a single-mode fiber and a dual wavelength transmission scheme is used to communicate between the ONU 140 and the HDT 130. In an alternate embodiment, a single wavelength scheme is used in which low reflectivity components are used to permit transmission and reception on one fiber.

A Telephony Interface Unit (TIU) 145 in the ONU 140 generates an analog Plain Old Telephone signal (POTs) which is transported to the residence 190 via a twisted wire pair, drop line cable 180. At the residence 190 a Network Interface Device (NID) 183 provides for high-voltage protection and serves as the interface and demarcation point between the twisted wire pair, drop line cable 180 and the twisted wire pairs 181 internal to the residence 190. In a preferred embodiment, the TIU 145 generates POTs signals for six residences 190, each having a separate twisted wire pair, drop line cable 180 connected to the ONU 140.

As shown in FIG. 2, a Broadband Interface Unit (BIU) 152 is located in the ONU 140 and generates broadband signals which contain video, data and voice information. The BIU 152 modulates data onto a RF carrier and transmits the data to the residence 190 over media 170, such as a coaxial, drop line cable or a twisted wire pair, drop line cable. The media 170 connects to the residence 190 at a splitter 177. The data then travels from the splitter 177 to the devices within the residence 190 over coaxial wiring 171 internal to the residence 190.

In a preferred embodiment, 64 ONUs 140 are served by each HDT 130 and each ONU 140 serves 8 residences 190. In an alternate embodiment, each ONU 140 serves 16 residences 190.

As shown in FIG. 2, each device connected to the internal coaxial wiring 171 will require an interface sub-system which can convert the current format of the signal being transmitted over the internal coaxial wiring 171 to the service interface required by the devices (i.e., telephone 194, TV 199, computer, or other devices). In a preferred embodiment, the PID 196 extracts time division multiplexed information carried on the internal coaxial wiring 171 and generates a telephone signal compatible with the telephone 194. Similarly, the TV set-top 198 converts digital video signals to analog signals compatible with the TV 199. Likewise, the EBR 191 generates a signal compatible with the computer.

In the system illustrated in FIG. 2, the NID 183 is located external to the residence 190, at what is known in the industry as the network demarcation point. For the delivery of telephony services the NID 183 is a passive device whose principal functions are lightning protection and the ability to troubleshoot the network by allowing connection of a telephone 194 to the twisted wire pair, drop line cable 180 to determine if wiring problems exist on the internal twisted wire pairs 181.

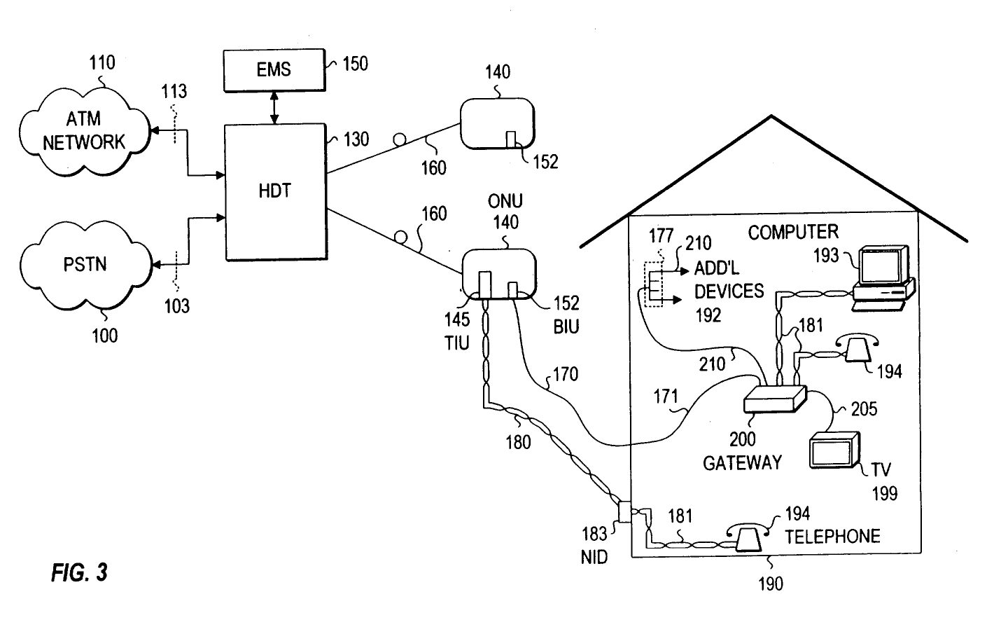

FIG. 3 illustrates a residential gateway (RG) 200 located within the residence 190. In the embodiment illustrated, the digital network is an FTTC network and the media 170 is a coaxial, drop line cable for connecting to and communicating with the RG 200. The RG 200 generates signals compatible with the devices in the residence 190, thus reducing the number of interface sub-systems required in the residence 190 to interface between the FTTC network and the devices (i.e., telephone 194, TV 199, and the computer 193). The devices are connected either directly or indirectly to the RG 200 instead of to an interface sub-system. For example, the computer 193 and the telephone 194 may be directly connected to the RG 200 via internal twisted wire pairs 181. As one skilled in the art would know, multiple computers 193 or telephones 194 could be connected to the RG 200 by using a splitter external to the RG 200, or by having additional Ethernet ports for the computers 193 or telephone jacks for the telephones 194 in the housing of the RG 200.

The TV 199 may be connected directly to the RG 200 via video cables 205. In a preferred embodiment, the video cables 205 used 25 for the direct RG-TV connection 205 are a four-conductor cable carrying S-video signals. As one skilled in the art would know, additional TVs 199 could be directly connected to the RG 200 by using a splitter or additional S-video connectors in the housing of the RG 200. The preferred embodiment would be to have additional S-video connectors so that the quality of the video signals would be maintained. Moreover, the TVs 199 directly connected to the RG 200 would have to be within close proximity to the RG 200 as S-video signals can only maintain their quality for a limited distance.

Additional devices 192, such as additional TVs 199, which are remotely located from the RG 200 (hereinafter referred to as remotely located TVs 199) may be connected to the RG 200. One embodiment connects the additional devices 192 to the RG 200 via media 210, such as internal coaxial cable wiring, and the splitter 177. That is, one port, such as a coaxial connector, on the RG 200 can connect multiple additional devices 192 to the RG 200. This type of connection is known as a point-to-multipoint connection. Alternatively, each additional device 192 could be directly connected to the RG 200 using the single media 210, the splitter 177 is not used. This type of connection is known as a point-to-point connection and would require the RG 200 to have multiple ports, such as coaxial connectors.

It would be obvious to one skilled in the art that any of the devices (TVs 199, telephones 194, computers 193, etc.) could be connected to the RG 200 with any type of cable that can transmit signals compatible with the particular device. Moreover, the RG 200 can include any type of ports that can receive signals compatible with a particular device.

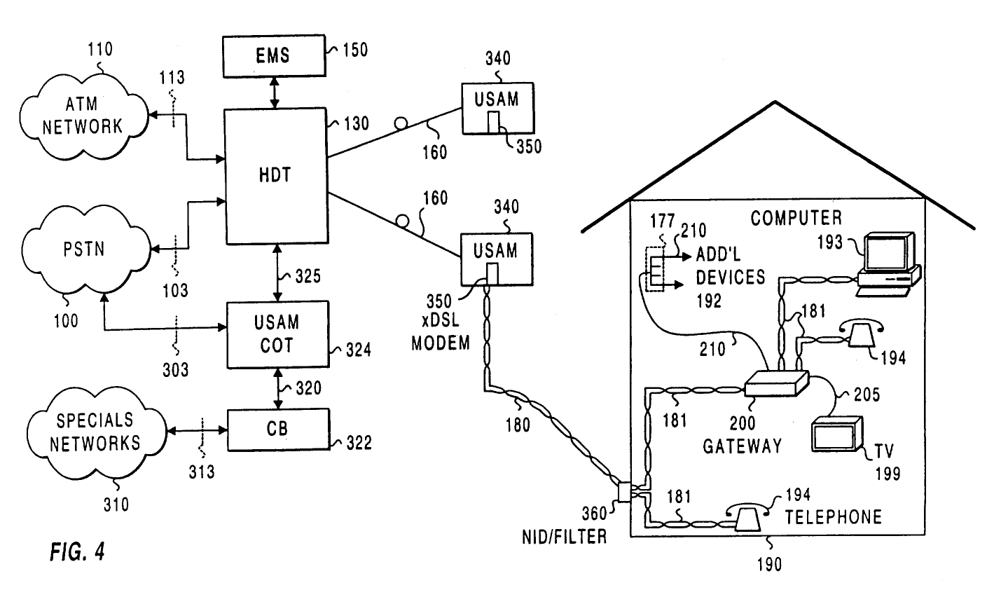

FIG. 4 illustrates an embodiment, in which the digital network is a Digital Subscriber Line (DSL) network. In this embodiment, the DSL network replaces the ONU 140 with a Universal Service Access Multiplexer (USAM) 340. The USAM 340 is located in the serving area, and is connected to the HDT 130 via optical fiber 160. A twisted wire pair, drop line cable 180 to provide communications to and from the RG 200.

The USAM 340 includes a xDSL modem 350 which provides for the transmission of high-speed digital data to and from the residence 190, over the twisted wire pair, drop line cable 180. When used herein, the term xDSL refers to any one of the twisted wire pair digital subscriber loop transmission techniques including High Speed Digital Subscriber Loop, Asymmetric Digital Subscriber Loop, Very high speed Digital Subscriber Loop, Rate Adaptive Digital Subscriber Loop, or other similar twisted wire pair transmission techniques. Such transmission techniques are known to those skilled in the art. The xDSL modem 350 contains the circuitry and software to generate a signal which can be transmitted over the twisted wire pair, drop line cable 180, and which can receive high speed digital signals transmitted from the RG 200 or other devices connected to the subscriber network.

Traditional analog telephone signals are combined with the digital signals for transmission to the residence 190. A NID/filter 360 replaces the NID 183 of FIGS. 2 and 3, and is used to separate the analog telephone signals from the digital signals. The majority of xDSL transmission techniques leave the analog voice portion of the spectrum (from approximately 400 Hz to 4,000 Hz) undisturbed. The analog telephone signal, once separated from any digital data signals in the spectrum, is sent to the telephone 194 over the internal twisted wire pairs 181. The digital signals that are separated at the NID/filter 360 are 20 sent from a separate port on the NID/filter 360 to the RG 200. The RG 200 serves as the interface to the other devices (TVs 199, computers 193, and additional telephones 194) in the residence 190. The connection of the devices within the residence 190 to the RG 200 is the same as described above with respect to FIG. 3.

The embodiment illustrated in FIG. 4 is a central office configuration, which includes a USAM Central Office Terminal (COT) 324 connected to the HDT 130. A USAM COT-HDT connection 325, is a twisted wire pair which transmits a STS3c signal in a preferred embodiment. A PSTN-USAM COT interface 303 is one of 30 the Bellcore specified interfaces including TR-TSY-000008, TR-NWT-000057 or TR-NWT-000303, which are all incorporated herein by reference. The USAM COT 324 has the same mechanical configuration as the USAM 340 in terms of power supplies and common control cards, but has line cards which support twisted wire pair interfaces to the PSTN 100 (including DS-1 interfaces) and cards which support STS3c transmission over the twisted wire pair of the USAM COT-HDT connection 325.

The embodiment illustrated in FIG. 4, also includes a Channel Bank (CB) 322 in the central office. The CB 322 is used to connect special networks 310, comprised of signals from special private or public networks, to the DSL network via a special networks-CB interface 313. In a preferred embodiment, a 10 CB-USAM COT connection 320 includes DS1 signals over twisted wire pairs.

The RG 200 can be located anywhere within the residence 190 (i.e., in any of the living spaces, in the basement, in the garage, in a wiring closet, in the attic), or external to the residence (i.e., on an external wall). For external locations, the RG 200 will require a hardened enclosure and components which work over a larger temperature range than those used for the RG 200 located internal to the residence 190. Techniques for developing hardened enclosures and selecting temperature tolerant components are known to those skilled in the art.

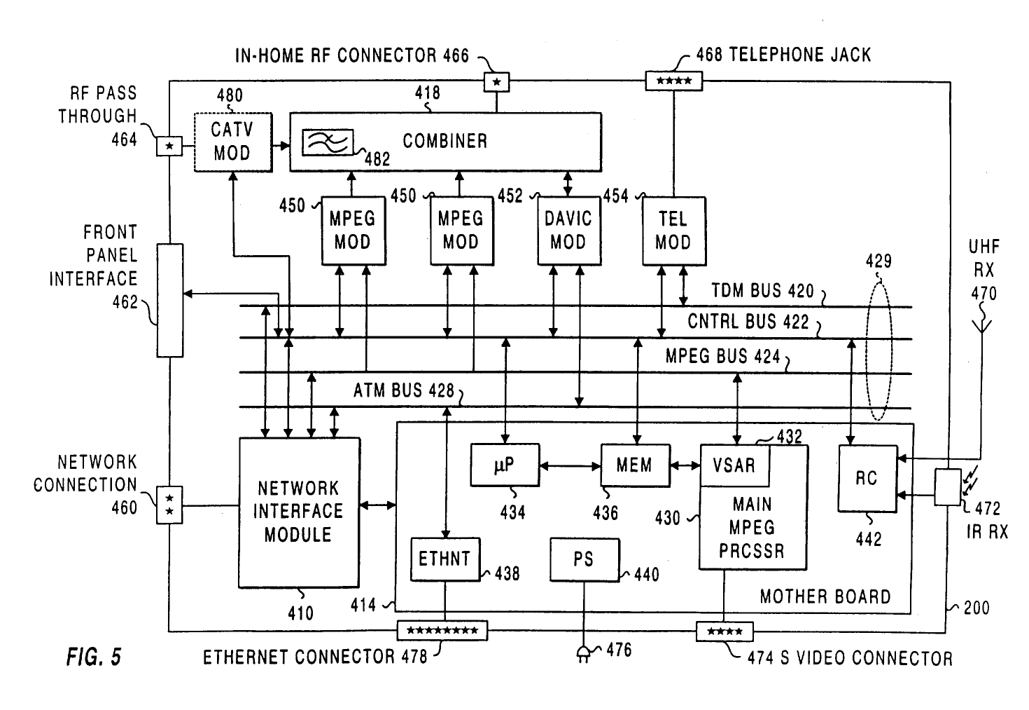

FIG. 5 illustrates one embodiment of the RG 200. The RG 200 includes a network connection 460 for connecting to the digital network. The network connection 460 will vary depending on the digital network that the RG is connecting to. That is, the network connection 460 will depend on whether the digital network for the area the residence 190 is located within is an FTTC network, a DSL network, or other type of digital network. For example, if the drop line from the digital network to the RG 200 is a coaxial cable (i.e., the FTTC network of FIG. 3) the network connection 460 should be a coaxial cable connector. If the drop line from the digital network to the RG 200 is twisted wire pair cable (i.e., the DSL network of FIG. 4) the network connection 460 should be a connector capable of receiving twisted wire pairs, such as a telephone jack. As one skilled in the art would know, the network connection 460 could be various different types of connectors as long as the connector is capable of receiving the signals being transmitted over the drop line from the digital network.

The network connection 460 is connected to a Network Interface Module (NIM) 410. The NIM 410 receives all data from and transmits all data to the digital network and thus contains the appropriate modem technology. As with the network connection 460, the type of NIM 410 utilized depends on the type of digital network that the RG 200 is connected to. In a preferred embodiment, different types of NIMs 410 are utilized for digital networks having coaxial drop line cables (i.e., the FTTC network of FIG. 3) than for digital networks having twisted wire pair drop line cables (i.e., the DSL network of FIG. 4).

Regardless of the type of NIM 410 utilized, the NIM 410 interfaces to a mother board 414 which provides the basic functionality of the RG 200. The mother board 414 may contain a microprocessor 434, memory 436, a power supply 440, a main MPEG processor 430, an Ethernet processor 438, and a Remote Control (RC) processor 442. As one skilled in the art would recognize, the mother board 414 could contain additional components, or some of the components illustrated as being part of the mother board 414 could removed from or located elsewhere within the RG 200, without departing from the scope of the current invention.

The RG 200 receives power from a power source, which in a preferred embodiment is an AC outlet, via a plug 476, which in a preferred embodiment is an AC plug. The power supply 440 converts the voltage from the AC outlet, for example 120 volts AC in a typical residence 190, to the voltages necessary for each of the components of the RG 200 to operate. The power supply 440 is illustrated as being an element of the mother board 414, but as one skilled in the art would know, the power supply 440 could be a separate component within the RG 200.

The microprocessor 434 controls the operation of the RG 200. For example, the microprocessor 434 may control the transfer of data between each of the elements of the RG 200. The memory 436 may store operating programs required by the microprocessor 434, data received from the digital network or any of the devices in the residence 190 connected to the RG 200, or other data or programs required by the RG 200.

The Ethernet processor 438 converts ATM cells received by the NIM 410 into the appropriate form for transmission to the devices, such as the computers 193. The computers 193 are connected to the RG 200 via an Ethernet connector 478 located in the housing of the RG 200. As illustrated in FIG. 5, the RG 200 has only one Ethernet connector 478. This would seem to infer that only one computer could be connected to the RG 200. However, as one skilled in the art would know, a splitter could be used to connect additional computers 193 to the RG 200. Furthermore, an alternative embodiment could include additional Ethernet connectors 478 located in the housing of the RG 200 so that additional computers 193 could be connected to the RG 200.

Within the main MPEG processor 430 there is a Video Segmentation and Re-assembly (VSAR) module 432 which constructs Motion Picture Experts Group (MPEG) packets from an ATM stream received from the NIM 410. In addition to constructing the MPEG packets, the VSAR module 432 can reduce jitter in the MPEG packets which arises from transmission of those packets over the ATM network 110, as well as constructing a useable MPEG stream in spite of lost ATM cells which contain partial MPEG packets. It would be obvious to one skilled in the art that the VSAR module 432 does not have to be part of the main MPEG processor 430. For example, the VSAR module 432 could be its own module on the mother board 414, could be its own subassembly, or could be part of another processor, such as the NIM 410.

While the VSAR module 432 has been described as constructing MPEG packets from received ATM streams, this is in no way intended to limit the scope of the invention. Rather, this is simply the current preferred embodiment. That is, digital data is currently transmitted over the digital network in ATM streams and digital video data is currently compressed according to an MPEG standard (currently the MPEG-2 standard). It is within the scope of the current invention to receive digital data from a digital network in any format and for the video data to be compressed in any format. That is, one skilled in the art could modify the VSAR module 432 to handle new transmission or compression formats without departing from the scope of the current invention.

The main MPEG processor 430 can also decompress the MPEG packets, which are constructed by the VSAR module 432, to generate video signal(s) compatible with present TVs 199. In one embodiment, the main MPEG processor 430 generates video signal(s) having an S-video format. The S-video signal(s) can be transmitted over an S-video connector 474 to a TV 199 having an S-video port via an S-video cable 205. As one skilled in the art knows, S-video signals are a higher quality video signal because the chrominance and luminance information are separated. The TV 199 receiving the S-video signals should be located in close proximity to the RG 200 to ensure the quality of the S-video signal. As illustrated, there is only one TV 199 connected to the RG 200 with the S-video cable 205 and only one S-video connector 474. However, this is not intended to limit the scope of the invention as it would be possible to have multiple TVs 199 (assuming they are located in close proximity to the RG 200) receive S-video signals from the RG 200 by splitting the signal transmitted from the single S-video connector 474 or by providing multiple S-video connectors in the housing of the RG 200.

In one embodiment, the main MPEG processor 430 may decompress multiple MPEG packets corresponding to multiple TV channel selections to generate video signal(s) compatible with the current TV format, which in the U.S. is currently the National TV System Committee (NTSC) format. The invention however is not limited to the NTSC format. It is well within the scope of the current invention for the TV signals to be generated in accordance with the current standard for the time, whether it be the NTSC format or a new format. For example, the main MPEG processor 430 may decompress three video streams simultaneously to generate three video signals associated with three TV channel selections. The TV signals may be transmitted to the TVs 199 by either combining and modulating each TV signal over one media or by modulating each TV signal over a separate media.

The RC processor 442 is capable of processing RC signals received by the RG 200. For example, in the embodiment illustrated in FIG. 5, the RC processor 442 receives optical signals, such as infrared (IR) signals, from an optical receiver 472, such as an IR receiver, and wireless signals, such as UHF signals, from a wireless receiver 470, such as a UHF receiver. One skilled in the art would recognize that the RC processor 442 could be designed to handle any type of channel select signals that were received from a variety of different RC devices. Moreover, one skilled in the art would recognize that the RC processor 442 is not limited to the illustrated configuration of being a module located on the mother board 414. For example, the RC processor 442 could be located on another board or could be incorporated as part of another module.

The embodiment of the RG 200 illustrated in FIG. 5, further includes the optical receiver 472. The optical receiver 472 receives channel select commands for the TV 199 that is directly connected to the RG 200, preferably via the S-video port 474. As stated earlier, this TV 199 will be in close proximity to the RG. In a preferred embodiment, the RG 200 would be located in a stereo cabinet with the TV 199 or on top of the TV 199, much like a VCR. As with a VCR, the TV 199 would be set to a particular channel, for example channel 3 or 4 just like a VCR, and the control of the channel selection for the TV 199 would then be controlled by the optical RC sending channel select commands to the RG 200 directly. While the illustrated embodiment is the preferred embodiment, the current invention is not limited to using an optical RC to control the TV 199 directly connected to the RG 200. For example, the RC could be a wireless RC or a hard wired RC device.

The RG 200 illustrated in FIG. 5, further includes the wireless receiver 470 for receiving channel select signals from the remotely located TVs 199 that are connected to the RG 200 and are located in separate rooms or even separate floors of the residence 190. As with the TV 199 directly connected to the and located in close proximity to the RG 200, the remotely located TVs 199 would be set to a particular channel, for example channel 3 or 4 just like a VCR, and the control of the channel selection for the remotely located TVs 199 would then be controlled by a wireless RC associated with each TV 199. The wireless RC transmits the channel select commands to the RG 200 directly.

The RG 200 also includes a set of buses 429 used to route information within the RG 200. As illustrated in FIG. 5, the set of buses 429 includes a Time Division Multiplexing (TDM) bus 420, a control bus 422, a MPEG bus 424, and an ATM bus 428.

The RG 200 may also include a number of optional modules which can be inserted into the RG 200. The optional modules include MPEG modules 450, a Digital Audio Visual Council (DAVIC) module 452, and a telephony module 454. All of the optional modules are connected to the control bus 422 in addition to being connected to at least one other bus which provides those modules with the appropriate types of data for the services supported by the module.

The MPEG modules 450 provide for decompression of MPEG packets which are constructed by the VSAR processor 432. The MPEG modules are associated with remotely located TVs 199. As with the output of the main MPEG processor 430, the output of the MPEG modules 450 is a signal having a format compatible with present TVs 199. The MPEG modules 450 can modulate the decompressed analog format video signal onto an available channel for transmission to the remotely located TVs 199 in the residence 190. In a preferred embodiment, the MPEG modules 450 are insertable cards. Thus, the cards could be added after an initial installation to handle additional TVs 199. For example, in one embodiment the main MPEG processor 430 may be capable of generating three TV signals so that the RG 200 can accommodate three TVs 199 without the need for any MPEG modules 450. If a fourth TV 199 was added, or one of the TVs 199 had picture-in-picture, a MPEG module 450 would be required to generate a fourth TV signal.

The DAVIC module 452 is for communicating with devices that have a signal format that is compatible with a signal format received from the digital network. That is, the DAVIC module transmits ATM signals to and receives ATM signal from these devices. Thus, the DAVIC module 452 allows the RG 200 to act as a pass through for these devices. These devices may include the interface sub-systems illustrated in FIGS. 1 and 2. This is beneficial because the RG 200 can be used in conjunction with previously purchased interface sub-systems if required or desired.

As illustrated in FIG. 5, the MPEG modules 450 and the DAVIC module 452 are connected to a combiner 418 which combines the RF signals from those modules. It should be noted that this embodiment has only one RF connector 466 so that the combiner 418 is necessary to combine all the TV signals and ATM signals so they can be transmitted over a single media 210 connected to the RF connector 466. If multiple RF connectors 466 were provided, it is possible that the combiner 418 would not be required or could be externally located. However, the combiner 418 can also add other RF signals, such as off-air broadcast TV signals or Community Antenna TV (CATV) signals supplied by a cable TV company. Signals from the antenna or cable system are coupled to the RF pass-through 464, which in a preferred embodiment is an F-connector. A low pass filter 482 is used in the combiner 418 to insure that the frequencies used by MPEG modules 450 are available. The output of the combiner 418 is connected to the RF connector 466, which in a preferred embodiment is an F-connector.

An optional CATV module 480 can be inserted into the RG 200 to allow for mapping of off-air or cable video channels from their original frequencies to new frequencies for in-home distribution. The RC processor 442 can control the channel selection and mapping via the control bus 422 which is connected to the CATV module 480. Either a hand-held optical RC or a wireless RC can be used to change the channel mapping of the CATV module 480.

The RG 200 includes a front panel interface 462, which provides for connectivity between the front panel controls (buttons) and the microprocessor 434. Through the front panel controls, the user can make channel changes as well as changing the configuration of the channels transmitted on the in-home coaxial network.

The RG 200 also includes a telephony module 454, which transmits and receives information from the TDM bus 420 and produces an analog telephone signal which is compatible with telephones 194. The interface for the telephones 194 is a telephone jack 468, which in a preferred embodiment is an RJ-11 jack.

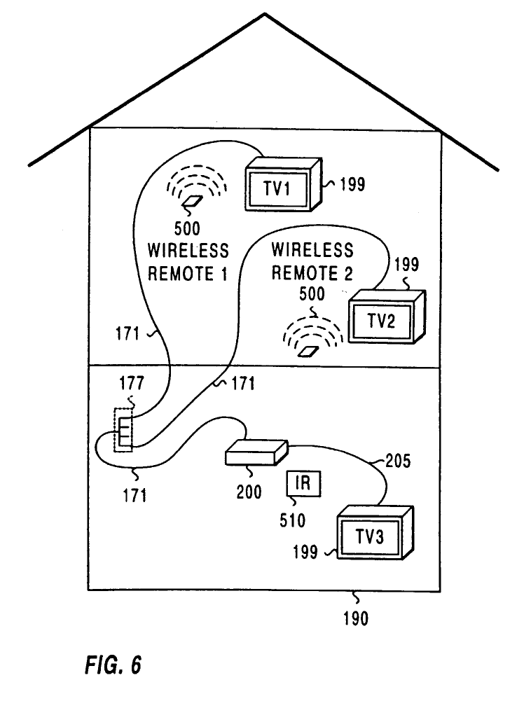

FIG. 6 illustrates one embodiment of how the RG 200 could be configured within the residence 190. As illustrated, the remotely located TVs 199 use a wireless RC 500 to transmit channel select commands to the RG 200. In particular, TVs 1 and 2 are located on a second floor while the RG 200 and TV3, which is directly connected to the RG 200 via the S-video connector 474, are located on a first floor of the residence 190. Wireless RCs 1 and 2 are associated with TVs 1 and 2 and transmit channel select commands for the associated TVs to the RG 200 as wireless signals. The wireless channel select commands are received by the RG 200 via the wireless receiver 470. The channel select commands for TV 3 are transmitted using an optical RC 510. The optical channel select command is received by the optical receiver 472 within the RG 200.

This embodiment illustrates TVs 1 and 2 being connected to the RG 200 via a splitter. This is in no way intended to limit the scope of the invention. Rather, as previously discussed it is within the scope of this invention to have multiple coaxial connectors within the housing of the RG 200 so that each remotely located TV 199 can be directly connected to the RG 200. As one skilled in the art would know, there is a limit to how many ports can be added to the housing so there is a limit to how many separate remotely located TVs 199 can be connected directly to the RG 200. Thus, it possible to have some of the remotely located TVs 199 connected directly to a port in the RG 200 and others that are connected to a port via the splitter 177.

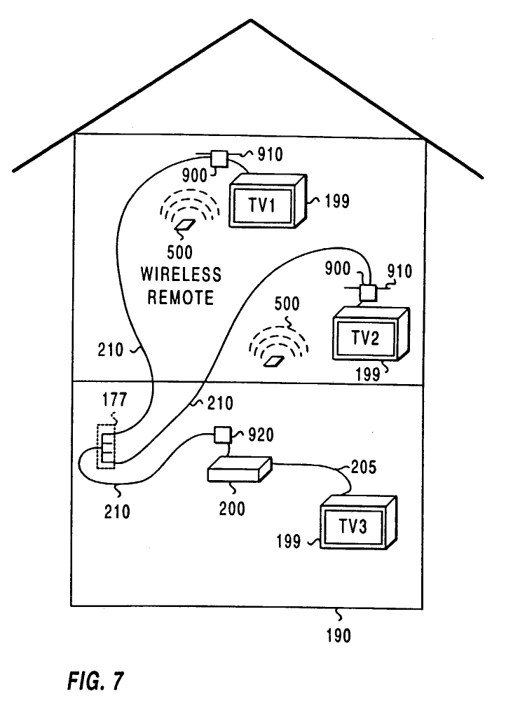

One drawback to the embodiment that utilizes wireless RCs 500 and the wireless receiver 470 within the RG 200 (as illustrated in FIG. 7), is that the further the wireless signals have to be transmitted and the more obstacles, such as walls, that the signals have to navigate around, the weaker the signal at the wireless receiver 470, and the more likely that the channel select command is lost or distorted. Moreover, the average consumer will more than likely point the wireless RC 500 at the TV 199, which is more than likely away from the RG 200 and the wireless receiver 470.

An alternative embodiment, for transmitting channel select commands from the remotely located TVs 199 to the RG 200 is illustrated in FIG. 7. In this embodiment, a Remote Antennae Package (RAP) 900 is connected to each remotely located TV 199. 10 The RAP 900 is a passive device for receiving and transmitting the wireless signals. The RAP 900 includes an antenna 910, such as a ¼ wave dipole antenna, located in close proximity to the TV 199, and preferably mounted to the TV 199. A wireless RC 500 is used to select a channel. The wireless RC 500 transmits a channel select command at one of the common wireless frequencies known to those skilled in the art. In a preferred embodiment, the wireless signal is transmitted at a frequency of approximately 433 MHz. The FCC regulations for wireless RCs imposes a maximum transmit power of 80.5 dbu V/m at a distance of 3 meters. One such wireless RC 500 that can be used along with the current invention is the RCK-431N manufactured by DAE-Ryung. The antenna 910 receives the channel select command and the RAP 900 transmits the wireless signal over the media 210 (i.e., coaxial cable) or the media 210 and the splitter 177.

A Remote Antenna Module (RAM) 920 which is located near, and preferably connected to the RG 200, receives the wireless signal. The RAM 920 demodulates the wireless signal and extracts the channel select command therefrom. In a preferred embodiment, the channel select command is extracted as an approximately 1 KHz audio signal. The RAM 920 then transmits the channel select command to the RG 200 for processing. The RAM 920 may be connected to the RG 200 with, for example audio wire better known as “speaker wire”. In an alternative embodiment, the RAM 920 may be directly mounted on the RG 200. In another alternative embodiment, the RAM 920 may be an integral part of the RG 200.

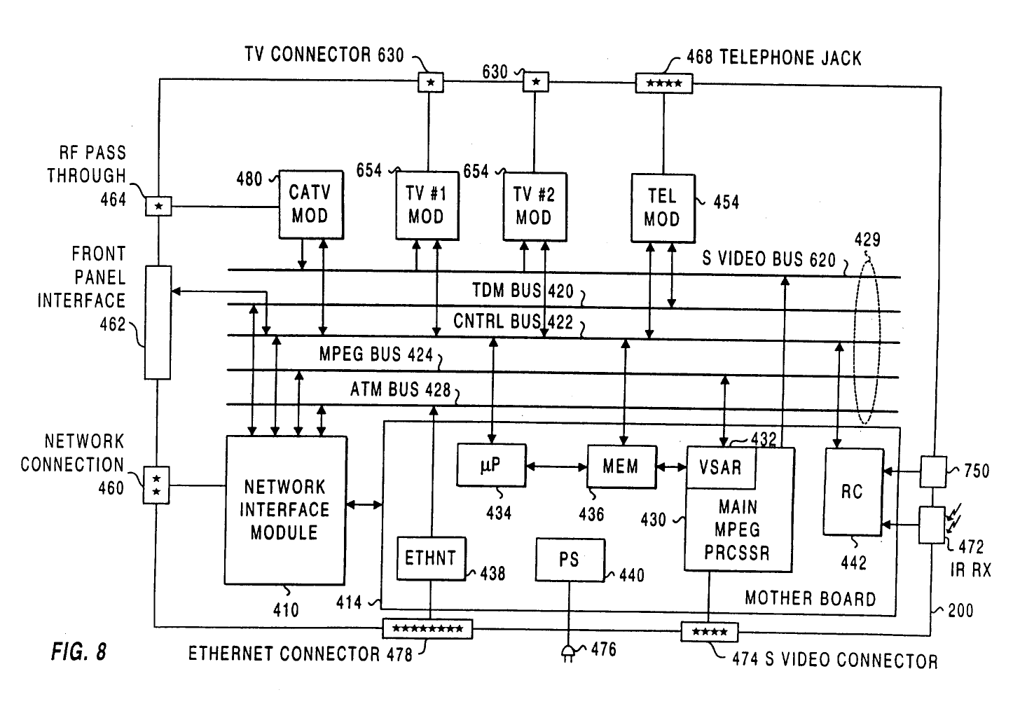

FIG. 8 illustrates an embodiment of the RG 200 that includes a port 750 for receiving channel select commands from the RAM 920. The channel select commands are provided directly to the RC processor 442. In this embodiment, a wireless antennae is not required to receive the wireless signals. Moreover, this embodiment includes multiple ports 630, such as TV connectors. Thus, the combiner 418 of FIG. 5 is not required. Rather, this embodiment illustrates TV modules 654 for modulating the appropriate video channel over the appropriate port 630.

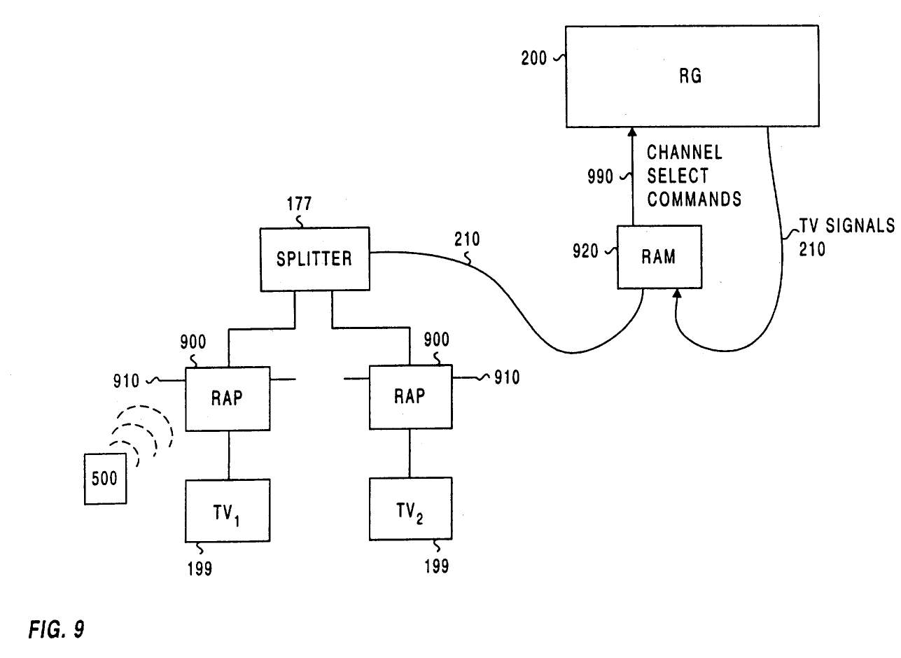

FIG. 9 illustrates a schematic diagram of an RG system utilizing the RAP 900 and the RAM 920 for communications between the RG 200 and the remotely located TVs 199. As illustrated, the RAM 920 is connected to the RG 200 with both speaker wire 990 and coaxial cable 210. The RAM 920 is further connected to a splitter 177 that in turn connects to two RAPS 900. The RAPS 900 are connected to the remotely located TVs 199. Channel select commands are received by the antennae 910 as wireless signals and the RAP 900 transmits the wireless signals over coaxial cable 210 to the RAM 920. The RAM 920 extracts the channel select commands and transmits them to the RG 200 over the speaker wire 990. TV signals are transmitted from the RG 200 to the TVs 199. As illustrated, the RAM 920 is connected to the RG 200 and thus receives the TV signals. However, the RAM 920 simply forwards the TV signals. The splitter 177 splits the TV signals so as to provide the TV signals to the two TVs 199. The TV signals simply pass through the RAP 900 in this direction.

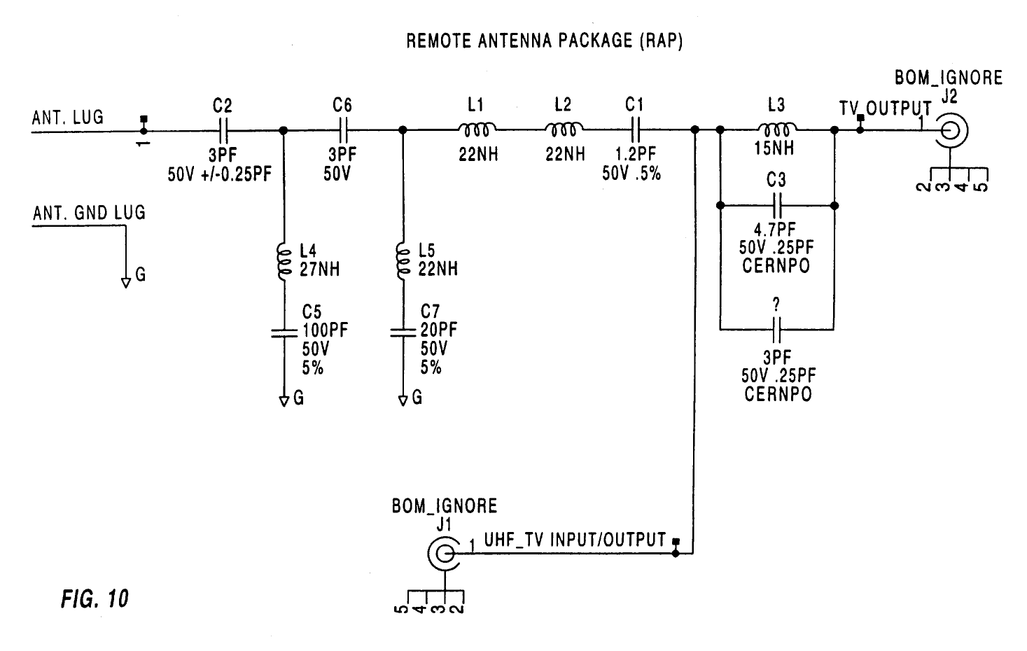

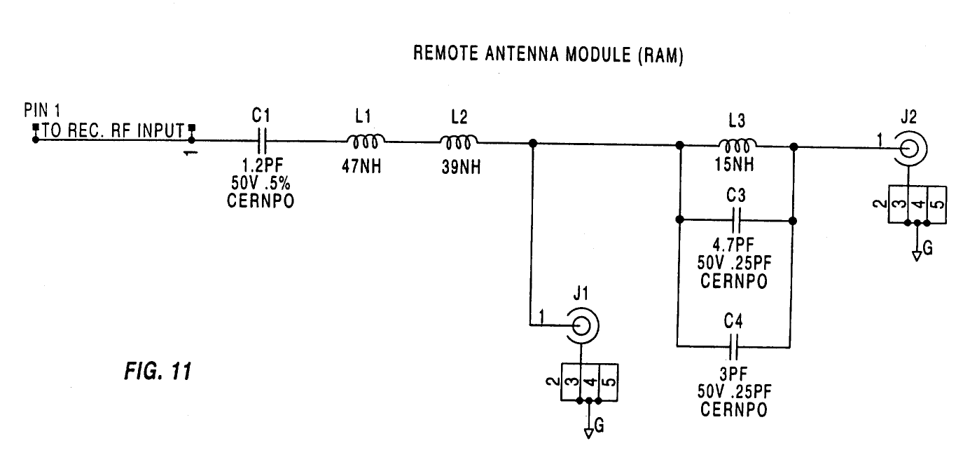

FIG. 10 illustrates one embodiment of the RAP 900. In addition to the antenna 910, the RAP includes a combination of inductors and capacitors. FIG. 11 illustrates one embodiment of RAM 920 that includes a combination of inductors and capacitors. FIGS. 10 and 11 depict values associated with each of the components, however, this is only an example and should not be construed as limiting the scope of this invention. Rather, as one skilled in the art would know, different components, configurations of components, and/or values of components could be used to accomplish the same or a similar purpose and would thus be well within the scope of the current invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. In a residential environment having a plurality of televisions locatable in at least two separate locations, a method of distributing video signals from a residential gateway, the method comprising:
receiving at least one channel select command from one of a plurality of remote control devices associated with a respective one of the plurality of televisions, wherein at least a first one of the plurality of remote control devices is a wireless remote control device that transmits the channel select command as a wireless signal;
receiving the wireless signal from the first one of the plurality of remote control devices at a remote antennae package connected to the first one of the plurality of televisions;
transmitting the wireless signal from the remote antennae package over media;
receiving the wireless signal from the media at a remote antennae module located in close proximity to the residential gateway;
demodulating the wireless signal and extracting the portion corresponding to the channel select command;
transmitting the channel select command to the residential gateway;
receiving a video signal from a telecommunications network in response to the at least one channel select command;
constructing, from the video signal, at least one series of video packets corresponding to the at least one channel select command;
transporting the at least one series of video packets over a video packet bus to a plurality of video decoders; and
decoding the at least one series of video packets to produce at least one television signal, the decoding performed by at least one of the plurality of video decoders.

2. The method of claim 1, wherein said demodulating the wireless signal includes demodulating the wireless signal and extracting therefrom the channel select command as an approximately 1 KHz signal.

3. A residential gateway for distributing video signals to a plurality of televisions locatable within at least two separate locations in a residential environment, said residential gateway comprising:
a plurality of remote control devices associated with a respective one of the plurality of televisions for transmitting channel select commands, wherein at least a first one of the plurality of remote control devices is a wireless remote control device that transmits the channel select command as a wireless signal;
a remote antennae package connected to the first one of the plurality of televisions associated with the first one of the plurality of remote control devices, the remote antennae package receiving the wireless signal and transmitting the wireless signal over media;
a remote antennae module for receiving the wireless signal from the remote antennae package, demodulating the wireless signal, extracting the portion corresponding to the channel select command, and transmitting the channel select command to the residential gateway;
a network interface module for receiving signals including video signals from a telecommunications network, wherein the received video signals correspond to the channel select commands;
means for constructing at least one series of video packets from the received video signals;
a plurality of video processors for decoding the at least one series of video packets to produce at least one television signal; and
a video packet bus for transporting the at least one series of video packets to said plurality of video processors.
